(19) United States
(12) Patent Application Publication
(10) Pub. No.: US 2026/0135436 A1
(43) Pub. Date: May 14, 2026

(54) MOTOR

(71) Applicant: NIDEC CORPORATION, Kyoto (JP)

(72) Inventor: Wei-Qian JIAN, Taipei City (TW)

(21) Appl. No.: 19/384,013

(22) Filed: Nov. 10, 2025

(30) Foreign Application Priority Data
Nov. 12, 2024 (JP) 2024-197424
Feb. 28, 2025 (JP) 2025-032275

(51) Int. Cl. H02K 5/22; H02K 1/12; H02K 1/22; H02K 7/08; H02K 16/04

(52) U.S. Cl. CPC H02K 5/225; H02K 1/12; H02K 1/22; H02K 7/08; H02K 16/04

(57) ABSTRACT

A motor includes a rotor, a first stator, and a second stator in an axial direction, first and second bus bars connected to the first and second stators, respectively, first and second connector portions fixed to the first and second bus bars, respectively, a housing, a first cable connected to the first connector portion, and a second cable connected to the second connector portion. The housing includes a first hole portion extending from the first connector portion toward one side in the axial direction, and a second hole portion extending from the second connector portion toward one side in the axial direction. The first cable is connected to the first connector portion from one side in the axial direction through the first hole portion. The second cable is connected to the second connector portion from one side in the axial direction through the second hole portion.

### CROSS-REFERENCE TO RELATED APPLICATIONS

The present application claims priority under 35 U.S.C. § 119 to Japanese Patent Application No. 2024-197424, filed on Nov. 12, 2024, and Japanese Patent Application No. 2025-032275, filed on Feb. 28, 2025, the entire contents of each application are hereby incorporated herein by reference.

### 1. Field of the Invention

The present disclosure relates to motors.

### 2. Background

In recent years, motors for a driving propeller of aerial vehicles such as electric vertical take-off and landing aircrafts have been developed. Such a motor is disposed directly below the propeller. Thus, the projection area of the motor is required to be downsized in an axial direction so as not to hinder the air blown by the propeller.

A cable connected to a control unit may be connected to the motor of such an aerial vehicle. In this case, the cable or a connection portion thereof may protrude from an outer shape of the motor, and thus, the air blown by the propeller may be hindered.

### SUMMARY

A motor according to an example embodiment of the present disclosure includes a rotor rotatable around a center axis, a first stator opposing the rotor in an axial direction and located on one side in the axial direction of the rotor, a second stator opposing the rotor in the axial direction and located on another side in the axial direction of the rotor, a first bus bar connected to the first stator, a second bus bar connected to the second stator, a first connector portion fixed to the first bus bar, a second connector portion fixed to the second bus bar, a housing to house the rotor, the first stator, the second stator, the first bus bar, and the second bus bar, a first cable connected to the first connector portion and drawn out to an outside of the housing, and a second cable connected to the second connector portion and drawn out to the outside of the housing. The housing includes a first hole portion extending from the first connector portion toward one side in the axial direction, and a second hole portion extending from the second connector portion toward one side in the axial direction. The first cable is connected to the first connector portion from one side in the axial direction through the first hole portion. The second cable is connected to the second connector portion from one side in the axial direction through the second hole portion. The second connector portion is on an outer side in a radial direction of the second stator. The second hole portion extends from the second connector portion through the outer side in the radial direction of the second stator and the first stator to one side of the housing in the axial direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of a motor according to an example embodiment of the present disclosure.

FIG. 2 is a perspective view of a bus bar unit and an insulator according to an example embodiment of the present disclosure.

FIG. 3 is an enlarged view of a region III illustrated in FIG. 1.

FIG. 4 is an enlarged view of a region IV illustrated in FIG. 1.

FIG. 5 is a cross-sectional view illustrating connection portions of a plurality of first bus bars, a plurality of first connector portions, and a plurality of first cables of an example embodiment of the present disclosure.

### DETAILED DESCRIPTION

Hereinafter, motors according to example embodiments of the present disclosure will be described with reference to the drawings. The scope of the present disclosure is not limited to the following example embodiments, and can be optionally changed within the scope of the technical idea of the present disclosure. In each drawing, a Z-axis is illustrated as appropriate. The Z-axis is a virtual axis parallel to a center axis J described later. Further, the Z-axis is the vertical direction in which the positive side is “upper side” and the negative side is “lower side”. However, a posture of the motor with respect to the vertical direction in the present specification is an example for description, and does not limit the posture of the motor during use.

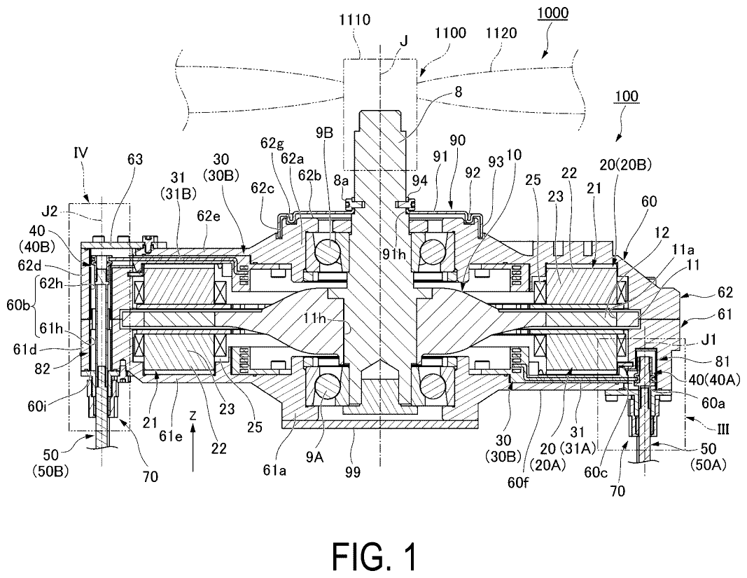

FIG. 1 is a cross-sectional view of a motor 100 according to an example embodiment.

The motor 100 of the present example embodiment is a motor included in a propulsion device 1000. The propulsion device 1000 is mounted onto, for example, an aerial vehicle. The propulsion device 1000 generates a propulsive force for moving the aerial vehicle. The propulsion device 1000 includes the motor 100 and a propeller 1100.

The propeller 1100 is attached to a shaft 8 of the motor 100 and is rotated around the center axis J by the motor 100. The propeller 1100 includes a base part 1110 fixed to the shaft 8 and a plurality of blade parts 1120 connected to the base part 1110. The plurality of blade parts 1120 extend in the radial direction and are disposed spaced apart in the circumferential direction.

The motor 100 of the present example embodiment includes a shaft 8, a pair of bearings 9A and 9B, a rotor 10, a pair of stators 20, a pair of bus bar units 30, a plurality of connector portions 40, a pair of insulators 81 and 82, a housing 60, a bearing cover 90, a lower cover 99, a pair of cables 50, and a pair of cable covers 70.

The motor 100 of the present example embodiment is an axial gap motor of a double-stator single-rotor type. Thus, the stator 20 of the present example embodiment faces the rotor 10 in the axial direction with a gap therebetween. The pair of stators 20 are disposed on both sides of the rotor 10 in the axial direction. The motor 100 of the present example embodiment is a three phase brushless motor. However, the number of phases of a drive power source may be more than three. The total number may be two phases. Hereinafter, each part of the motor 100 will be described in detail.

The rotor 10 is rotatable about the center axis J. In the present specification, the center axis J is a virtual line and extends in the vertical direction. In the following description, the axial direction of the center axis J may be simply referred to as “axial direction”, a direction corresponding to the lower side in the axial direction may be referred to as “one side in the axial direction”, and a direction corresponding to the upper side may be referred to as “the other side in the axial direction”. In the following description, a radial direction around the center axis J may be simply referred to as “radial direction” and a circumferential direction around the center axis J may be simply referred to as “circumferential direction”.

The rotor 10 is disposed between the pair of stators 20. The rotor 10 of the present example embodiment includes a holder 11 and a plurality of rotor magnets 12. The configuration of the rotor 10 of the present example embodiment is an example, and the present example embodiment is not limited thereto.

The holder 11 has a substantially annular shape around the center axis J. The holder 11 is provided with a center hole 11h extending in the axial direction. The center hole 11h has a substantially circular shape around the center axis J. The holder 11 includes a plurality of magnet housing portions 11a. The magnet housing portion 11a is a hole extending through the holder 11 in the axial direction. The plurality of magnet housing portions 11a are arranged at equal intervals in the circumferential direction.

The rotor magnets 12 are housed in the magnet housing portions 11a different from each other and fixed to the holder 11. The plurality of rotor magnets 12 are disposed at equal intervals in the circumferential direction. The rotor magnet 12 faces the stator 20 in the axial direction. Each rotor magnet 12 has a magnetic pole having a magnetization direction facing the axial direction. In this example, orientations of the magnetic poles of the rotor magnets 12 disposed adjacent to each other in the circumferential direction are opposite to each other. However, Halbach array may also be adopted as the arrangement of the rotor magnets. In Halbach array, some of the magnets are disposed with magnetic poles misaligned with the axial direction.

The shaft 8 is disposed in a state in which the center axis thereof coincides with the center axis J, and extends in the axial direction. The shaft 8 is fixed to an inner circumferential surface of the center hole 11h of the rotor 10. The shaft 8 rotates around the center axis J together with the rotor 10. The shaft 8 is rotatably supported with respect to the housing 60 by a pair of bearings 9A and 9B. One bearing 9A is located on the lower side (−Z) of the rotor 10. The other bearing 9B is located on the upper side (+Z) of the rotor 10. The propeller 1100 is fixed to an upper end portion of the shaft 8. A bearing cover 90 is fixed to the outer circumferential surface of the shaft 8 between a region fixed to the propeller 1100 and a region supported by the bearing 9B.

The stator 20 has an annular shape surrounding the center axis J when viewed from the axial direction. One of the pair of stators 20 is located on the lower side (−Z) of the rotor 10, and the other is located on the upper side (+Z) of the rotor 10. According to the present example embodiment, the pair of stators 20 sandwich the rotor 10 and each stator 20 forms the rotating magnetic flux, so that a high torque can be generated in the rotor 10.

In the following description, when the pair of stators 20 are distinguished from each other, one of the stators 20 located on the lower side is referred to as a first stator 20A, and the other located on the upper side is referred to as a second stator 20B. That is, the motor 100 includes, as the stators 20, the first stator 20A located on the lower side (−Z) of the rotor 10 and the second stator 20B located on the upper side (+Z) of the rotor 10. The first stator 20A and the second stator 20B have the same structure. The first stator 20A and the second stator 20B are disposed to be vertically inverted.

Each of the stators 20 includes a stator core 21 and a plurality of coils 25. The stator core 21 has a substantially annular shape around the center axis J. The shaft 8 is disposed on the inner side in the radial direction of the stator core 21. The stator core 21 includes a back yoke portion 22 and a teeth portion 23. The back yoke portion 22 has a disk shape around the center axis J. The teeth portion 23 has a columnar shape protruding from the back yoke portion 22 toward the rotor 10 side. The plurality of teeth portions 23 are arranged at equal intervals along the circumferential direction.

The coil 25 is mounted on the teeth portion 23 via an insulating member (for example, insulating paper)that is not illustrated. The coil 25 is formed of, for example, a coil wire wound around the outer circumferential surface of the teeth portion 23. In the present example embodiment, the plurality of coils 25 are classified into coils 25 of three phases corresponding to a U phase, a V phase, and a W phase. Alternating currents with phases shifted by 120° from each other flow through the coils 25 of the three phases, respectively.

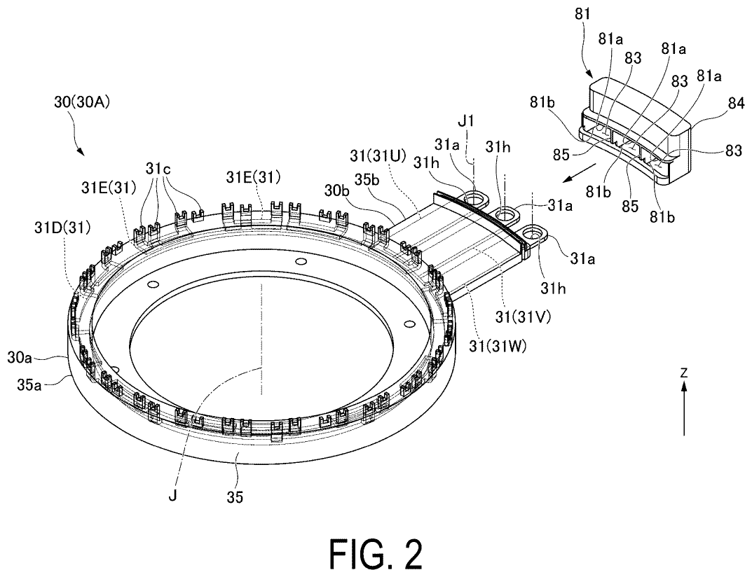

FIG. 2 is a perspective view of the bus bar unit 30 and the insulator 81 of the present example embodiment. As illustrated in FIG. 2, the bus bar unit 30 includes an annular portion 30a having an annular shape surrounding the center axis J, and a protruding portion 30b protruding from the annular portion 30a toward the outer side in the radial direction.

The bus bar unit 30 includes a plurality of bus bars 31 and a bus bar holder 35. The bus bar holder 35 is made of an insulating resin material. The bus bar holder 35 supports the plurality of bus bars 31. The bus bar holder 35 of the present example embodiment includes the plurality of bus bars 31 embedded therein. That is, the bus bar holder 35 is formed by insert molding so that the plurality of bus bars 31 are disposed inside the bus bar holder 35.

The bus bar holder 35 includes an annular support portion 35a that supports the bus bar 31 at the annular portion 30a, and a protruding support portion 35b that supports the bus bar 31 at the protruding portion 30b. The annular support portion 35a has an annular shape around the center axis J. The protruding support portion 35b protrudes from the outer circumferential surface of the annular support portion 35a toward the outer side in the radial direction. All of the bus bars 31 are at least partially embedded in the annular support portion 35a, and, further, some of the bus bars 31 are embedded in the protruding support portion 35b.

As illustrated in FIG. 2, the plurality of bus bars 31 include a plurality of phase bus bars 31U, 31V, and 31W, one neutral point bus bar 31D, and a plurality of inter-coil bus bars 31E. Each of the plurality of bus bars 31 includes one or more coil connection portions 31c. Each of the plurality of bus bars 31 is connected to the coil 25 at the coil connection portion 31c. That is, the plurality of bus bars are connected to the stator 20. The neutral point bus bar 31D connects the coils 25 having different phases to each other. The neutral point bus bar 31D constitutes a neutral point of star connection. The inter-coil bus bar 31E connects, in series, two coils 25 adjacent to each other in the circumferential direction. In the present example embodiment, a case will be described in which the plurality of coils 25 are connected to each other by the plurality of bus bars 31 to constitute the star connection. However, the plurality of bus bars 31 may be constituted to delta connect the plurality of coils 25.

The bus bar unit 30 of the present example embodiment is provided with three phase bus bars 31U, 31V, and 31W. Currents corresponding to the U phase, the V phase, and the W phase, respectively, and having phases different from each other flow through the three phase bus bars 31U, 31V, and 31W. The phase bus bars 31U, 31V, and 31W are connected to an external power source via the connector portion 40 and the cable 50, which will be described later.

The phase bus bars 31U, 31V, and 31W are partially embedded in the protruding support portion 35b. Further, the phase bus bars 31U, 31V, and 31W each include a connection end portion 31a protruding from an end portion of the protruding support portion 35b on the outer side in the radial direction toward the outer side in the radial direction. That is, the phase bus bars 31U, 31V, and 31W are exposed from the bus bar holder 35 at the connection end portions 31a. The connection end portions 31a of the three phase bus bars 31U, 31V, an 31W are disposed side by side along the circumferential direction. The connection end portion 31a has a plate shape with the axial direction as a thickness direction. The connection end portion 31 a is provided with a through-hole 31h. The three connection end portions 31a are housed in the insulator 81.

As illustrated in FIG. 1, the pair of bus bar units 30 are connected to different stators 20, respectively. One of the pair of bus bar units 30 is located on the lower side (−Z) of the rotor 10 and is connected to the first stator 20A. The other of the pair of bus bar units 30 is located on the upper side (+Z) of the rotor 10 and is connected to the second stator 20B. In the following description, when the pair of bus bar units 30 are distinguished from each other, one located on the lower side is referred to as a first bus bar unit 30A, and the other located on the upper side is referred to as a second bus bar unit 30B. Further, the plurality of bus bars 31 of the first bus bar unit 30A are referred to as first bus bars 31A, and the plurality of bus bars 31 of the second bus bar unit 30B are referred to as second bus bars 31B. That is, the motor 100 includes, as the bus bars 31, the first bus bars 31A connected to the first stator 20A and the second bus bars 31B connected to the second stator 20B. The first bus bar unit 30A and the second bus bar unit 30B have the same structure. The first bus bar unit 30A and the second bus bar unit 30B are disposed to be vertically and horizontally inverted. Further, in the following description, an axis passing through the center of the through-hole 31h of the first bus bar 31A and extending in the axial direction is referred to as a first axis J1, and an axis passing through the center of the through-hole 31h of the second bus bar 31B and extending in the axial direction is referred to as a second axis J2.

The connector portions 40 are fixed to the connection end portions 31a of the first bus bar 31A and the second bus bar 31B, respectively. The cables 50 are connected to the connector portions 40, respectively. The connector portion 40 is made of a metal material having excellent conductivity such as a copper alloy.

In the following description, the connector portion 40 fixed to the first bus bar 31A is referred to as a first connector portion 40A, and the connector portion 40 fixed to the second bus bar 31B is referred to as a second connector portion 40B. The connection end portions 31a of the three first bus bars 31A are disposed side by side along the circumferential direction. Thus, a plurality of the first connector portions 40A are disposed side by side along the circumferential direction. Similarly, the connection end portions 31a of the three second bus bars 31B are disposed side by side along the circumferential direction. Thus, a plurality of the second connector portions 40B are disposed side by side along the circumferential direction.

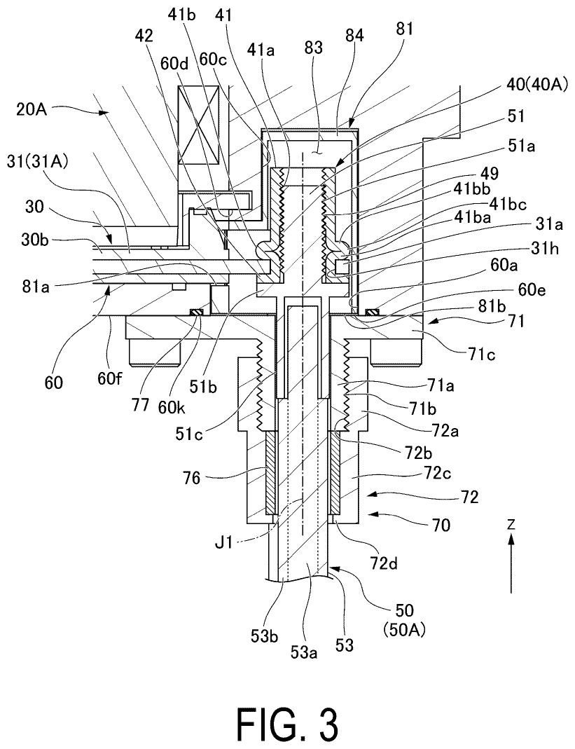

FIG. 3 is an enlarged view of a region III illustrated in FIG. 1. FIG. 3 is a view illustrating a connection portion between the first bus bar 31A, the first connector portion 40A, and the cable 50.

The first connector portion 40A is fixed to the connection end portion 31a of the first bus bar 31A. The first connector portion 40A includes a tubular portion 41 and a flange portion 42. The tubular portion 41 is inserted into the through-hole 31h of the first bus bar 31A. The tubular portion 41 has a tubular shape around the first axis J1. The flange portion 42 protrudes from the end portion of the tubular portion 41 on the lower side (−Z) toward the outer side in the radial direction of the first axis J1.

The tubular portion 41 includes a female screw portion 41a provided on an inner circumferential surface thereof, and a crimping portion 41b that bulges toward the outer side in the radial direction with respect to the first axis J1. The female screw portion 41a of the first connector portion 40A is located on the upper side (+Z) of the crimping portion 41b.

The crimping portion 41b is provided over the entire circumference of the outer circumferential surface of the tubular portion 41 and around the first axis J1. The crimping portion 41b includes a first crimping section 41ba, a second crimping section 41bb, and a third crimping section 41bc. The first crimping section 41ba has an annular shape that protrudes from an outer circumferential surface of the tubular portion 41 toward the outer side in the radial direction. The second crimping section 41bb is located on the connection end portion 31a side (that is, the lower side) of the first crimping section 41ba in the axial direction. The second crimping section 41bb has an annular shape that protrudes from the outer circumferential surface of the tubular portion 41 toward the outer side in the radial direction. The third crimping section 41bc connects end portions of the first crimping section 41ba and the second crimping section 41bb on the outer side in the radial direction to each other. The connection end portion 31a is sandwiched between the second crimping section 41bb and the flange portion 42. That is, the crimping portion 31a is sandwiched between the connection end portion 41b and the flange portion 42.

The crimping portion 41b of the present example embodiment is formed by plastically deforming the tubular portion 41 after the tubular portion 41 is inserted into the through-hole 31h. That is, the crimping portion 41 b is formed by crimping. The connection end portion 31a is sandwiched between the crimping portion 41b and the flange portion 42 in the axial direction, so that the first connector portion 40A is fixed to the first bus bar 31A and is electrically connected to the first bus bar 31A.

The cable 50 is connected to the connector portion 40. In the following description, the cable 50 connected to the first connector portion 40A is referred to as a first cable 50A. The first cable 50A includes a first terminal 51 and a cable body 53.

The first terminal 51 is provided at a tip portion of the first cable 50A. The first terminal 51 has a screw shape that is fastened to the female screw portion 41a of the first connector portion 40A. The first terminal 51 includes a male screw portion 51a, a terminal flange portion 51b, and a terminal connection portion 51c.

The male screw portion 51a is inserted into the female screw portion 41a. The terminal flange portion 51b protrudes from a lower end portion of the male screw portion 51a toward the outer side in the radial direction. The terminal flange portion 51b contacts the flange portion 42 of the connector portion 40 in a state where the male screw portion 51a is inserted or screwed into the female screw portion 41a. The terminal connection portion 51c is located on the lower side (−Z) of the male screw portion 51a and the terminal flange portion 51b. The terminal connection portion 51c is connected to the cable body 53.

The cable body 53 includes a copper wiring portion 53a and a coating portion 53b surrounding the copper wiring portion 53a. The copper wiring portion 53a is fixed to and electrically connected to the first terminal 51. In the present example embodiment, the copper wiring portion 53a is connected to the first terminal 51 by being sandwiched by the crimped terminal connection portion 51c. Alternatively, the first terminal 51 and the copper wiring portion 53a may be connected by soldering or welding.

A conductive material 49 is interposed between the female screw portion 41a of the first connector portion 40A and the male screw portion 51a of the first terminal 51. The conductive material 49 is, for example, a conductive tape or a conductive paste. When the conductive material 49 is the conductive tape, the tape as the conductive material 49 is inserted into the female screw portion 41a together with the male screw portion 51a in the state of being wound around the outer circumferential surface of the male screw portion 51a. In addition, when the conductive material 49 is the conductive paste, the paste as the conductive material 49 is applied to the outer circumferential surface of the male screw portion 51a and is inserted into the female screw portion 41a together with the male screw portion 51a.

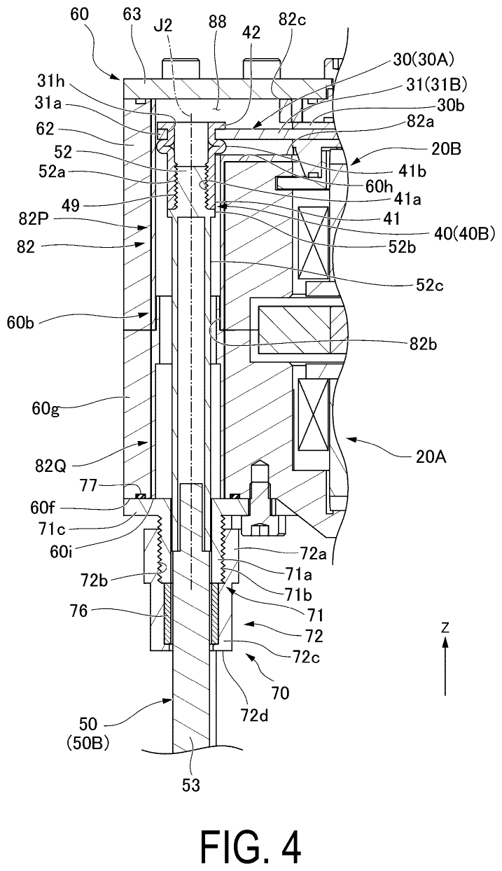

FIG. 4 is an enlarged view of a region IV illustrated in FIG. 1. FIG. 4 is a view illustrating a connection portion between the second bus bar 31B and the cable 50.

The second connector portion 40B is fixed to the connection end portion 31a of the second bus bar 31B. The second connector portion 40B includes the tubular portion 41 and the flange portion 42 similarly to the first connector portion 40A (refer to FIG. 3), and is disposed with the first connector portion 40A being vertically inverted. The tubular portion 41 is inserted into the through-hole 31h of the second bus bar 31B. The tubular portion 41 has a tubular shape around the second axis J2. The flange portion 42 protrudes from the end portion of the tubular portion 41 on the upper side (+Z) toward the outer side in the radial direction of the second axis J2.

The tubular portion 41 includes the female screw portion 41a provided on an inner circumferential surface thereof, and the crimping portion 41b that bulges toward the outer side in the radial direction with respect to the second axis J2. The female screw portion 41a of the second connector portion 40B is located on the lower side (−Z) of the crimping portion 41b. The crimping portion 41b is provided over the entire circumference of the outer circumferential surface of the tubular portion 41 around the second axis J2. The crimping portion 31a is sandwiched between the connection end portion 41b and the flange portion 42. Accordingly, the crimping portion 41b is formed by plastically deforming the tubular portion 41 after the tubular portion 41 is inserted into the through-hole 31h. The connection end portion 31 a is sandwiched between the crimping portion 41b and the flange portion 42 in the axial direction, so that the second connector portion 40B is fixed to the second bus bar 31B. The second connector portion 40B is electrically connected to the second bus bar 31B.

The cable 50 is connected to the second connector portion 40B. In the following description, the cable 50 connected to the second connector portion 40B is referred to as a second cable 50B. The second cable 50B includes a second terminal 52 and a cable body 53.

The second terminal 52 is provided at a tip portion of the second cable 50B. The second terminal 52 has a screw shape that is fastened to the female screw portion 41a of the second connector portion 40B, similarly to the first terminal 51 (refer to FIG. 3). The second terminal 52 includes a male screw portion 52a inserted into the female screw portion 41a, a terminal flange portion 52b in contact with the lower end surface of the tubular portion 41, and a terminal connection portion 52c connected to the cable body 53. The terminal connection portion 52c is a tube made of copper in this example, but may be a rod made of copper or aluminum. Further, the conductive material 49, which is the conductive tape or the conductive paste, is interposed between the female screw portion 41a of the second connector portion 40B and the male screw portion 52a of the second terminal 52.

The connector portion 40 of the present example embodiment can be easily connected to the bus bar 31 by forming the crimping portion 41b. Thus, as a step of connecting the connector portion 40 to the bus bar 31, it is not necessary to perform a step involving heating such as soldering or welding, and a connection step can be simplified. As a result, the motor 100 can be manufactured at low cost.

According to the present example embodiment, the connector portion 40 has a tubular shape extending in the axial direction. The connector portion 40 is connected to the cable 50 by inserting the cable 50 in the axial direction. According to the present example embodiment, the connector portion 40 and the cable 50 connected to the connector portion 40 are unlikely to protrude in the radial direction when the motor 100 is viewed from the axial direction. As a result, the projection area of the motor 100 in the axial direction can be reduced.

According to the present example embodiment, the male screw portion 51a of the cable 50 is fastened to the female screw portion 41a of the connector portion 40, so that the cable 50 can be connected to the connector portion 40. Thus, the connection step of connecting the cable 50 to the connector portion 40 can be simplified. In addition, since the connection of the cable 50 to the connector portion 40 can be easily released, maintenance of the motor 100 accompanied by replacement of components can be easily performed.

According to the present example embodiment, the conductive material 49 is interposed between the female screw portion 41a and the male screw portions 51a and 52a, and fills a minute gap between the female screw portion 41a and the male screw portion 51a. Accordingly, a large connection area between the first connector portion 40A and the first terminal 51 can be ensured, and the electric resistance between the first connector portion 40A and the first terminal 51 can be reduced.

As illustrated in FIG. 1, the insulator 81 is attached to the first bus bar unit 30A. The insulator 82 is attached to the second bus bar unit 30B. The insulators 81 and 82 are made of an insulating resin material. The insulators 81 and 82 are supported by the housing 60. In the following description, the insulator attached to the first bus bar unit 30A is referred to as a first insulator 81, and the insulator fixed to the second bus bar unit 30B is referred to as a second insulator 82.

As illustrated in FIG. 2, the first insulator 81 is provided with a plurality of first opening portions 81a that open toward an inner side in the radial direction and a plurality of second opening portions 81b that open toward the lower side (−Z).

The first opening portion 81a opens toward the inner side in the radial direction. The plurality of first opening portions 81a are disposed side by side along the circumferential direction. The connection end portion 31a of the phase bus bar 31U, the connection end portion 31a of the phase bus bar 31V, and the connection end portion 31a of the phase bus bar 31W are inserted into the plurality of first opening portions 81a, respectively.

One first opening portion 81a and one second opening portion 81b communicate with each other to constitute a first communication space 83. That is, the first insulator 81 of the present example embodiment is provided with three first communication spaces 83 arranged along the circumferential direction. Different connection end portions 31a are disposed in the three first communication spaces 83, respectively.

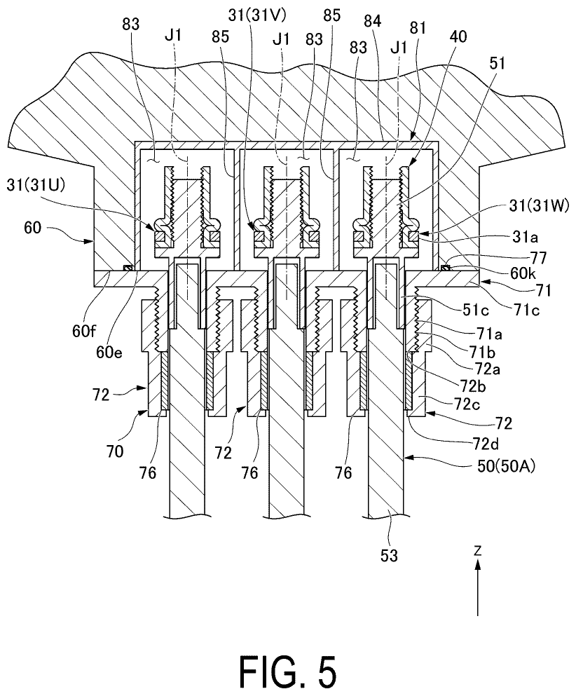

FIG. 5 is a cross-sectional view illustrating connection portions between the plurality of first bus bars 31A, the plurality of first connector portions 40A, and the plurality of first cables 50A. As illustrated in FIG. 5, the first insulator 81 includes a surrounding wall portion 84 and two partition wall portions (wall portions) 85.

The surrounding wall portion 84 covers the three first communication spaces 83. The surrounding wall portion 84 is disposed between the housing 60 and the first communication space 83. The surrounding wall portion 84 insulates the connection end portions 31a of the phase bus bars 31U, 31V, and 31W, which are disposed in the three first communication spaces 83, respectively, from the housing 60.

The partition wall portion 85 partitions the first communication spaces 83 adjacent to each other. The partition wall portion 85 is located between the connection end portions 31a of the phase bus bars 31U, 31V, and 31W different from each other. The partition wall portion 85 insulates the connection end portions 31a from each other. The partition wall portion 85 insulates the connector portions 40 connected to the connection end portions 31a, respectively, from each other. According to the present example embodiment, insulation is easily ensured between the bus bars 31 through which currents having different phases flow, and the reliability of the motor 100 can be enhanced. In addition, since the insulation between the connection end portions 31a can be ensured by the partition wall portion 85, the connection end portions 31a can be disposed close to each other. Accordingly, downsizing of the motor 100 can be achieved.

As illustrated in FIG. 4, the second insulator 82 includes a first member 82P and a second member 82Q. The first member 82P is attached to the second bus bar unit 30B. The second member 82Q is located on the lower side (−Z) of the first member 82P and is attached to the first member 82P.

The second insulator 82 is provided with a plurality of (three) first opening portions 82a that are open toward the inner side in the radial direction, a plurality of (three) second opening portions 82b that are open toward the lower side (−Z), and a plurality of (three) third opening portions 82c that are open toward the upper side (+Z). One first opening portion 82a, one second opening portion 82b, and one third opening portion 82c communicate with each other to constitute a second communication space 88. That is, the first member 82P is provided with a plurality of (three) the second communication spaces 88. The three second communication spaces 88 are disposed side by side in the circumferential direction (that is, the depth direction of the paper surface of FIG. 4). The connection end portions 31a of the phase bus bars 31U, 31V, and 31W different from each other are disposed in the three second communication spaces 88, respectively. Although not illustrated, similarly to the first insulator 81 (refer to FIG. 5), the first member 82P is provided with a wall portion that partitions the second communication spaces 88 adjacent to each other. The wall portion is located between the connection end portions 31a of the phase bus bars 31U, 31V, and 31W different from each other, and insulates the connection end portions 31a from each other.

The second member 82Q has a tubular shape extending in the axial direction. The second member 82Q extends the second opening portion 82b of the first member 82P toward the lower side (−Z). An upper end portion of the second member 82Q is connected to the second opening portion 82b. A lower end portion of the second member 82Q is open toward the lower side (−Z) at the lower end portion of the housing 60.

As illustrated in FIG. 1, the housing 60 houses the shaft 8, the pair of bearings 9A and 9B, the rotor 10, the pair of stators 20, the pair of bus bar units 30, the plurality of connector portions 40, and the pair of insulators 81 and 82.

The housing 60 includes a first housing member 61, a second housing member 62, and a lid member 63. The second housing member 62 is located on the upper side of the first housing member 61. The lid member 63 is located on the upper side of the second housing member 62. The first housing member 61 and the second housing member 62 are fixed to each other. The lid member 63 is fixed to the second housing member 62. In the present example embodiment, the first housing member 61, the second housing member 62, and the lid member 63 are made of a metal material such as aluminum. The first housing member 61, the second housing member 62, and the lid member 63 may be made of a material other than a metal material, such as a resin.

The first housing member 61 includes a first circumferential wall portion 61d, a first bearing holder portion 61a, and a lower wall portion 61e. The first circumferential wall portion 61d has a substantially tubular shape extending in the axial direction around the center axis J. The first circumferential wall portion 61d surrounds the first stator 20A from the outer side in the radial direction. The lower wall portion 61e has a substantially annular plate shape around the center axis J. The lower wall portion 61e connects an outer circumferential surface of the first bearing holder portion 61a and a lower end portion of the first circumferential wall portion 61d to each other. The lower wall portion 61e covers the first stator 20A from the lower side.

The first circumferential wall portion 61d is provided with a first through-hole portion 61h and a first hole portion 60a. The first hole portion 60a and the first through-hole portion 61h are located on opposite sides in the radial direction across the center axis J. The first through-hole portion 61h extends in the axial direction and extends through the first circumferential wall portion 61d.

The first bearing holder portion 61a is disposed on the lower side of the first stator 20A. The first bearing holder portion 61a has a tubular shape surrounding the center axis J from the outer side in the radial direction. The first bearing holder portion 61a holds the bearing 9A. A lower cover 99 covering the bearing 9A and the lower end portion of the shaft 8 is fixed to a lower end surface of the first bearing holder portion 61a.

The second housing member 62 includes a second circumferential wall portion 62d, a second bearing holder portion 62a, and an upper wall portion 62e. The second circumferential wall portion 62d has a substantially tubular shape extending in the axial direction around the center axis J. The second circumferential wall portion 62d surrounds the second stator 20B from the outer side in the radial direction. A lower end portion of the second circumferential wall portion 62d is fixed to an upper end portion of the first circumferential wall portion 61d. The upper wall portion 62e has a substantially annular plate shape around the center axis J. The upper wall portion 62e connects an outer circumferential surface of the second bearing holder portion 62a and the upper end portion of the second circumferential wall portion 62d to each other. The upper wall portion 62e covers the second stator 20B from the upper side (+Z).

The second circumferential wall portion 62d is provided with the second through-hole portion 62h. The second through-hole portion 62h extends in the axial direction and extends through the second circumferential wall portion 62d. The lower end portion of the second through-hole portion 62h is connected to the first through-hole portion 61h. The first through-hole portion 61h and the second through-hole portion 62h constitute a second hole portion 60b. An opening on the upper side of the second through-hole portion 62h is closed by the lid member 63. When the lid member 63 is removed from the second housing member 62, an internal space of the second hole portion 60b can be exposed toward the upper side, and the second connector portion 40B disposed inside the second hole 60b can be assembled or replaced from the upper side.

The second bearing holder portion 62a is disposed on the lower side of the first stator 20A. The second bearing holder portion 62a has a tubular shape surrounding the center axis J from the outer side in the radial direction. The second bearing holder portion 62a holds the bearing 9B. That is, the housing 60 includes the second bearing holder portion 62a having a tubular shape that holds the bearing 9B. The second bearing holder portion 62a includes an upper surface 62b facing the upper side (+Z) and an outer circumferential surface 62c facing the outer side in the radial direction. The upper surface 62b is provided with a groove portion 62g having an annular shape extending along the circumferential direction around the center axis J.

Next, the first hole portion 60a and the second hole portion 60b provided in the housing 60 will be described in detail. The first hole portion 60a and the second hole portion 60b are provided on the circumferential wall portions (the first circumferential wall portion 61d and the second circumferential wall portion 62d) surrounding the internal space of the housing 60 from the outer side in the radial direction. The first hole portion 60a is located on the outer side in the radial direction of the first stator 20A. The second hole portion 60b is located on the outer side in the radial direction of the first stator 20A and the second stator 20B. The first hole portion 60a and the second hole portion 60b are located on opposite sides in the radial direction across the center axis J.

Both the first hole portion 60a and the second hole portion 60b extend along the axial direction. The first hole portion 60a and the second hole portion 60b are open at a surface (hereinafter, referred to as a lower end surface 60f) of the housing 60 facing the lower side. In the following connection, an opening of the first hole portion 60a at the lower end surface 60f is referred to as a first hole opening portion 60e. On the other hand, the opening of the second hole portion 60b at the lower end surface 60f is referred to as a second hole opening portion 60i.

As illustrated in FIG. 3, the first hole portion 60a includes an axial extension portion 60c and a radial extension portion 60d. The axial extension portion 60c extends in the axial direction and opens toward the lower side (−Z) at the first hole opening portion 60e located at the lower end surface 60f of the housing 60. The radial extension portion 60d extends toward the inner side in the radial direction to connect the internal space of the housing 60 and the axial extension portion 60c to each other. The first hole portion 60a extends through the outer side in the radial direction of the first stator 20A from the first connector portion 40A to the lower side (−Z) of the housing 60.

A tip portion of the protruding portion 30b of the first bus bar unit 30A is inserted into the radial extension portion 60d from the inner side in the radial direction. Accordingly, the plurality of connection end portions 31a located at the tip end of the protruding portion 30b and the first connector portions 40A fixed to the connection end portions 31a are disposed inside the first hole portion 60a. Thus, the first connector portion 40A is located on the outer side in the radial direction of the first stator 20A. In the present example embodiment, the first connector portion 40A is located immediately above the first hole opening portion 60e. That is, the first connector portion 40A overlaps the first hole opening portion 60e when viewed from the axial direction. The first hole portion 60a extends from the first connector portion 40A toward the lower side (−Z).

The first cable 50A is inserted into the first hole portion 60a from the first hole opening portion 60e. The first terminal 51 of the first cable 50A is connected to the first connector portion 40A inside the first hole portion 60a. That is, the first cable 50A is connected to the first connector portion 40A from the lower side (−Z) through the first hole portion 60a.

The first insulator 81 is disposed inside the first hole portion 60a. The surrounding wall portion 84 of the first insulator 81 covers an inner surface of the first hole portion 60a. The connection end portion 31a is passed through the first opening portion 81a of the first insulator 81, and the first cable 50A is passed through the second opening portion 81b. The connection end portion 31a, the first connector portion 40A, and the first terminal 51 are disposed in the first communication space 83 of the first insulator 81. The first insulator 81 insulates the connection end portion 31a, the first connector portion 40A, and the first terminal 51 from the housing 60.

As illustrated in FIG. 4, the second hole portion 60b includes an axial extension portion 60g and a radial extension portion 60 h. The axial extension portion 60g extends in the axial direction and opens toward the lower side (−Z) at the second hole opening portion 60i located at the lower end surface 60f of the housing 60. The radial extension portion 60h extends toward the inner side in the radial direction to connect the internal space of the housing 60 and the axial extension portion 60g to each other. The second hole portion 60b extends from the second connector portion 40B, through the outer side in the radial direction of the second stator 20B and the first stator 20A, to the lower side (−Z) of the housing 60.

The tip portion of the protruding portion 30b of the second bus bar unit 30B is inserted into the radial extension portion 60h from the inner side in the radial direction. Accordingly, the plurality of connection end portions 31a located at the tip end of the protruding portion 30b and the second connector portions 40B fixed to the connection end portions 31a are disposed inside the second hole portion 60b. Thus, the second connector portion 40B is located on the outer side in the radial direction of the second stator 20B. In the present example embodiment, the second connector portion 40B is located immediately above the second hole opening portion 60i. That is, the second connector portion 40B overlaps the second hole opening portion 60i when viewed from the axial direction. Thus, the second hole portion 60b extends from the second connector portion 40B toward the lower side (−Z).

The second cable 50B is inserted into the second hole portion 60b from the second hole opening portion 60i. The second terminal 52 of the second cable 50B is connected to the second connector portion 40B inside the second hole portion 60b. That is, the second cable 50B is connected through the second hole portion 60b to the second connector portion 40B from the lower side (−Z).

The second insulator 82 is disposed inside the second hole portion 60b. Similarly to the first insulator 81, the connection end portion 31a, the second connector portion 40B, and the second terminal 52 are disposed in the second communication space 88 of the second insulator 82. The second insulator 82 insulates the connection end portion 31a, the second connector portion 40B, and the second terminal 52 from the housing 60.

As illustrated in FIG. 1, according to the present example embodiment, the housing 60 is provided with the first hole portion 60a and the second hole portion 60b each extending in the axial direction and opening toward the lower side at the lower end surface of the housing 60. The first cable 50A is connected to the first bus bar 31A via the first connector portion 40A inside the first hole portion 60a, and is drawn out from the lower side to the lower portion of the housing 60. Similarly, the second cable 50B is connected to the second bus bar 31B via the second connector portion 40B inside the second hole portion 60b, and is drawn out from the lower side to the lower portion of the housing 60. Thus, the protrusion of the connector portion 40 and the cable 50 toward the outer side in the radial direction from the housing 60 is reduced. That is, according to the present example embodiment, the connector portion 40 can be downsized in the radial direction of the motor 100. As a result, the projection area of the motor 100 in the axial direction is reduced, and air blown to the lower side by the propeller 1100 is less hindered by the motor 100 located on the lower side of the propeller 1100.

According to the present example embodiment, both the first hole opening portion 60e of the first hole portion 60a and the second hole opening portion 60i of the second hole portion 60b face the lower side. Further, the first cable 50A and the second cable 50B extend from the lower end surface 60f of the housing 60 toward the lower side. Thus, when the propulsion device 1000 is used outdoors, moisture such as rainwater is less likely to enter the housing 60 via the first hole opening portion 60e and the second hole opening portion 60i. According to the present example embodiment, the reliability of the motor 100 regarding moisture can be enhanced.

The bearing cover 90 is located on the upper side (+Z) of the second bearing holder portion 62a. The bearing cover 90 of the present example embodiment is made of a metal material and is formed by press working. However, the bearing cover 90 may be made of a resin material.

The bearing cover 90 includes a cover body portion 91, an annular protrusion 92, a tubular portion 93, and a fixed tubular portion 94. The cover body portion 91 has a plate shape with the axial direction as a thickness direction. The cover body portion 91 has a circular shape around the center axis J. The cover body portion 91 faces the bearing 9B and the upper surface 62b of the second bearing holder portion 62a in the axial direction. A through-hole 91h having a circular shape through which the shaft 8 passes is provided at the center of the cover body portion 91.

The fixed tubular portion 94 has a tubular shape protruding from an inner edge of the through-hole 91h toward the upper side (+Z). A gap between the inner circumferential surface of the fixed tubular portion 94 and the outer circumferential surface of the shaft 8 is sealed by a sealing material or the like. The fixing tubular portion 94 is provided with a fixing hole extending therethrough in the radial direction. The fixing screw 8a is inserted into the fixing hole. The fixing screw 8a is screwed into a screw hole on the outer circumferential surface of the shaft 8. Thus, the bearing cover 90 is fixed to the outer circumferential surface of the shaft 8. The bearing cover 90 rotates around the center axis J together with the shaft 8.

The annular protrusion 92 is provided on the cover body portion 91. The annular protrusion 92 protrudes toward the lower side (−Z) with respect to the cover body portion 91. The annular protrusion 92 has an annular shape around the center axis J. The annular protrusion 92 is inserted into the groove portion 62g of the second bearing holder portion 62 a. The lower end portion of the annular protrusion 92 faces a bottom surface of the groove portion 62g via a gap inside the groove portion 62g.

The tubular portion 93 has a tubular shape around the center axis J. The tubular portion 93 is connected to an outer edge of the cover body portion 91. Thus, the tubular portion 93 is located on the outer side in the radial direction of the annular protrusion 92. The tubular portion 93 protrudes toward the lower side (−Z) with respect to the cover body portion 91. The tubular portion 93 surrounds the outer circumferential surface 62c of the second bearing holder portion 62a from the outer side in the radial direction.

The motor 100 according to the present example embodiment includes the bearing cover 90 fixed to the shaft 8, extending from the shaft 8 toward the outer side in the radial direction, and covering the bearing 9B from the upper side (+Z). In particular, in the present example embodiment, the upper end portion of the shaft 8 extends from the housing 60 toward the upper side and is fixed to the propeller 1100. Thus, the bearing 9B is exposed toward the upper side. Water droplets such as rain easily penetrate, from the upper side, the motor 100 for rotating the propeller 1100 as in the present example embodiment. According to the present example embodiment, the bearing cover 90 covers the bearing 9B from the upper side, so that the moisture that contacts the bearing 9B can be reduced and the impairment of lubricity of the bearing 9B can be reduced. Furthermore, penetration of moisture to the stator 20 and the rotor 10 inside the housing 60 passing through the bearing 9B can be reduced, so that the reliability of the motor 100 can be enhanced.

In particular, the bearing cover 90 of the present example embodiment has a shape that conforms to a surface shape of the second bearing holder portion 62a. That is, the bearing cover 90 includes the cover body portion 91 and the annular protrusion 92 extending along the upper surface 62b of the second bearing holder portion 62 a and the groove portion 62g of the upper surface 62b, and the tubular portion 93 extending along the outer circumferential surface 62c. Thus, the gap between the bearing cover 90 and the second bearing holder portion 62a, which may be a moisture penetration path, can be formed into an intricate labyrinth structure. Accordingly, the penetration of moisture from the end portion of the gap between the bearing cover 90 and the second bearing holder portion 62a on the outer side in the radial direction toward the inner side in the radial direction can be reduced.

As illustrated in FIG. 5, the cable cover 70 is fixed to the lower end surface 60f of the housing 60. The cable cover 70 surrounds the cable 50 from the outer side in the radial direction with respect to the first axis J1. Here, the cable cover 70 attached to the first cable 50A will be described with reference to FIG. 5. The cable cover 70 is also attached to the second cable 50B. The cable cover 70 attached to the second cable 50B has the same configuration as the cable cover 70 attached to the first cable 50A.

The cable 50 of the present example embodiment is inserted inside the housing 60 and connected to the bus bar 31 inside the housing 60. The cable cover 70 of the present example embodiment functions as a waterproof cover that suppresses the penetration of moisture into the housing 60 along the outer circumferential surface of the cable 50. the cable 50 of the present example embodiment is connected to the bus bar 31 by fastening the male screw portion 51a of the first terminal 51 (or the second terminal 52) provided at the tip end of the cable 50 to the female screw portion 41a of the connector portion 40. The cable cover 70 of the present example embodiment functions as a locking member that reduces the rotation of the cable 50 in the circumferential direction of the male screw portion 51a.

The cable cover 70 includes one base 71, three caps 72, three first seals 76, and one second seal 77.

The base 71 is fixed to the housing 60. The base 71 includes three tubular screw portions 71a and one flange portion 71c.

The three tubular screw portions 71a each have a tubular shape extending in the axial direction around the first axis J1. Thus, the three tubular screw portions 71a are disposed side by side along the circumferential direction. An inner diameter of the tubular screw portion 71a is slightly larger than outer diameters of the cable body 53 and the terminal connection portion 51c. The cable 50 is inserted into the tubular screw portion 71a. The tubular screw portion 71a surrounds the cable 50 from the outer side in the radial direction of the first axis J1. A male screw portion 71b is provided on an outer circumferential surface of the tubular screw portion 71a.

The flange portion 71c protrudes from an upper end portion of the tubular screw portion toward the outer side in the radial direction. The flange portion 71c has a plate shape extending along a plane orthogonal to the axial direction. An upper surface of the flange portion 71c is in contact with the lower end surface 60f of the housing 60. A groove portion 60k surrounding the first hole opening portion 60e when viewed from the axial direction is provided on the lower end surface 60f of the housing 60. Further, the second seal 77 having an annular shape is disposed on the groove portion 60k. Thus, the second seal 77 surrounds the first hole opening portion 60e when viewed from the axial direction. The second seal 77 is made of, for example, an elastic member such as rubber or an elastomer resin. The upper surface of the flange portion 71c covers the groove portion 60k. The second seal 77 is sandwiched between the upper surface of the flange portion 71c and a bottom surface of the groove portion 60k. That is, the second seal 77 is sandwiched between the flange portion 71c and the lower end surface 60f of the housing 60. According to the present example embodiment, the second seal 77 seals the gap between the flange portion 71c and the housing 60, so that the penetration of moisture from the gap between the flange portion 71c and the housing 60 into the housing 60 can be reduced.

A cap 72 is fixed to the base 71. The cap 72 has a tubular shape around the first axis J1. The cap 72 includes a nut portion 72a, a holding tubular portion 72c, and an inner protruding portion 72d.

The nut portion 72a has an annular shape around the first axis J1. A female screw portion 72b is formed on an inner circumferential surface of the nut portion 72a. The outer circumferential surface of the nut portion 72a is preferably formed in a hexagonal nut shape in order to rotate the cap 72. The male screw portion 71b of the tubular screw portion 71a is engaged with the female screw portion 72b. The male screw portion 71b of the tubular screw portion 71a is inserted into the nut portion 72a.

The holding tubular portion 72c has a tubular shape surrounding the first axis J1. The holding tubular portion 72c extends from the nut portion 72a toward the lower side (−Z). The holding tubular portion 72c surrounds the outer circumferential surface of the cable body 53 from the outer side in the radial direction of the first axis J1 via a gap.

The inner protruding portion 72d has an annular shape surrounding the first axis J1. The inner protruding portion 72d protrudes from a lower portion of the holding tubular portion 72c toward the inner side in the radial direction of the first axis J1. The inner diameter of the inner protruding portion 72d is slightly larger than the outer diameter of the cable body 53. The upper surface of the inner protruding portion 72d faces the lower surface of the tubular screw portion 71a in the axial direction.

The first seal 76 has an annular shape around the first axis J1. The first seal 76 is made of, for example, an elastic member such as rubber or an elastomer resin. The first seal 76 of the present example embodiment has a tubular shape extending in the axial direction. The first seal 76 is disposed on the inner side of the holding tubular portion 72c. The first seal 76 surrounds the cable body 53 from the outer side in the radial direction of the first axis J1. That is, the first seal 76 is disposed between the cable body 53 and the holding tubular portion 72c in the radial direction of the first axis J1. The first seal 76 is disposed between the lower surface of the tubular screw portion 71a and the upper surface of the inner protruding portion 72d in the axial direction. That is, the first seal 76 is sandwiched between the tubular screw portion 71a and the inner protruding portion 72d on the inner side in the radial direction of the holding tubular portion 72c.

In the present example embodiment, the nut portion 72a of the cap 72 is fastened to the male screw portion 71b of the tubular screw portion 71a, so that the upper surface of the inner protruding portion 72d approaches the lower surface of the tubular screw portion 71a. Accordingly, the first seal 76 is pressed against the lower side of the tubular screw portion 71a to seal the lower surface of the tubular screw portion 71a, and reduces the penetration of moisture along the lower surface of the tubular screw portion 71a. Further, the first seal 76 is compressed in the axial direction between the upper surface of the inner protruding portion 72d and the lower surface of the tubular screw portion 71a. The first seal 76 compressed in the axial direction is pressed against the outer circumferential surface of the cable body 53. Accordingly, the first seal 76 can seal the outer circumferential surface of the cable body 53, and reduce the penetration of liquid into the housing 60 along the outer circumferential surface of the cable body 53. Further, the first seal 76 is pressed against the outer circumferential surface of the cable body 53, suppresses the rotation of the cable 50 around the first axis J1. This can inhibit the first terminal 51 of the cable 50 from loosening from the connector portion 40.

Although the example embodiments and the modifications of the present disclosure have been described above, the respective configurations in the example embodiments, combinations thereof, and the like are examples, and additions, omissions, substitutions, and other changes of the configurations can be made without departing from the spirit of the present disclosure. The present disclosure is not limited to the example embodiments.

Motors according to example embodiments of the present disclosure are applicable to various devices. The motors can be applied to, for example, a rotating electrical machine such as a generator including a propeller that rotates by receiving wind. In this case, the rotating electrical machine may be a three phase alternating current generator. The application of the rotating electrical machine is not particularly limited. The configurations described above in the present specification can be combined as appropriate within a range in which they do not contradict each other.

Note that the present technology can have configurations such as the following.

(A1) A motor including a rotor rotatable around a center axis, a first stator opposing the rotor in an axial direction and located on one side in the axial direction of the rotor, a second stator opposing the rotor in the axial direction and located on another side in the axial direction of the rotor, a first bus bar connected to the first stator, a second bus bar connected to the second stator, a first connector portion fixed to the first bus bar, a second connector portion fixed to the second bus bar, a housing to house the rotor, the first stator, the second stator, the first bus bar, and the second bus bar, a first cable connected to the first connector portion and drawn out to an outside of the housing, and a second cable connected to the second connector portion and drawn out to the outside of the housing.

The housing includes a first hole portion extending from the first connector portion toward one side in the axial direction, and a second hole portion extending from the second connector portion toward one side in the axial direction. The first cable is connected to the first connector portion from one side in the axial direction through the first hole portion. The second cable is connected to the second connector portion from one side in the axial direction through the second hole portion. The second connector portion is on an outer side in a radial direction of the second stator. the second hole portion extends from the second connector portion through the outer side in the radial direction of the second stator and the first stator to one side of the housing in the axial direction.

(A2) The motor according to (A1), further including a cable cover to surround at least one of the first cable or the second cable from an outer side in a radial direction with respect to an axis extending in the axial direction. The cable cover includes a base fixed to the housing, a cap fixed to the base, and a first seal having an annular shape. The base includes a tubular screw portion to surround the cable from the outer side in the radial direction of the axis and including an outer circumferential surface on which a male screw portion is provided. The cap includes a nut portion into which the male screw portion is inserted, a holding tubular portion having a tubular shape surrounding the axis and extending from the nut portion toward one side in the axial direction, and an inner protruding portion having an annular shape and protruding from an end portion of the holding tubular portion on one side in the axial direction toward the inner side in the radial direction of the axis. The first seal is sandwiched between the tubular screw portion and the inner protruding portion on an inner side in the radial direction of the holding tubular portion.

(A3) The motor according to (A2), wherein the base includes a flange portion protruding from an end portion of the tubular screw portion on the other side in the axial direction toward the outer side in the radial direction, and a second seal is between the flange portion and a surface of the housing opposing one side in the axial direction.

(A4) The motor according to any one of (A1) to (A3), wherein at least one of the first bus bar or the second bus bar includes a connection end portion having a plate shape with the axial direction as a thickness direction, the connection end portion is provided with a through-hole, at least one connector portion of the first connector portion or the second connector portion includes a tubular portion inserted into the through-hole, and a flange portion protruding from an end portion of the tubular portion in the axial direction toward the outer side in the radial direction. The tubular portion includes a female screw portion provided on an inner circumferential surface, and a crimping portion configured to bulge toward the outer side in the radial direction and sandwich the connection end portion together with the flange portion. A terminal having a screw shape to be fastened to the female screw portion is provided at a tip portion of at least one cable of the first cable or the second cable.

(A5) The motor according to (A4), wherein a conductive tape or a conductive paste is between the female screw portion and the terminal.

(A6) The motor according to (A4) or (A5), further including a plurality of the bus bars through which flow currents having phases different from each other, a plurality of the connector portions fixed, respectively, to different ones of the bus bars, a plurality of the cables connected, respectively, to different ones of the connector portions, and an insulator including a wall portion located between the connection end portions of the bus bars different from each other.

(A7) The motor according to any one of (A1) to (A6), further including a shaft fixed to the rotor and extending in the axial direction around the center axis, a bearing located on the other side in the axial direction of the rotor and configured to rotatably support the shaft, and a bearing cover fixed to the shaft, extending from the shaft toward the outer side in the radial direction, and configured to cover the bearing from the other side in the axial direction.

(A8). The motor according to (A7), wherein the housing includes a bearing holder portion having a tubular shape configured to hold the bearing, a groove portion having an annular shape and extending along a circumferential direction is provided on a surface of the bearing holder portion facing the other side in the axial direction, and the bearing cover includes a cover body portion having a plate shape with the axial direction as a thickness direction, an annular protrusion having an annular shape and protruding toward one side in the axial direction with respect to the cover body portion and inserted into the groove portion, and a tubular portion protruding toward one side in the axial direction, with respect to the cover body portion, on the outer side in a radial direction of the annular protrusion and surrounding the outer circumferential surface of the bearing holder portion from the outer side in the radial direction.

Further, the present technology can have configurations such as the following.

(B1) A motor including a rotor rotatable around a center axis, a stator opposing the rotor, a bus bar connected to the stator, a connector portion fixed to the bus bar, a housing that houses the rotor, the stator, and the bus bar and a cable connected to the connector portion and drawn out to an outside of the housing, wherein the bus bar includes a connection end portion having a plate shape, the connection end portion is provided with a through-hole, the connector portion includes a tubular portion inserted into the through-hole, and a flange portion protruding from an end portion of the tubular portion in the axial direction toward the outer side in the radial direction, the tubular portion includes, a female screw portion provided on an inner circumferential surface, and a crimping portion bulging toward the outer side in the radial direction, a terminal having a screw shape to be fastened to the female screw portion is provided at a tip portion of the cable, the crimping portion includes, a first crimping section having an annular shape and protruding from an outer circumferential surface of the tubular portion toward the outer side in the radial direction, a second crimping section having an annular shape and located on the connection end portion side of the first crimping section in the axial direction and protruding from an outer circumferential surface of the tubular portion toward the outer side in the radial direction, and a third crimping section connecting end portions on the outer side in the radial direction of the first crimping section and the second crimping section to each other, and the connection end portion is sandwiched between the second crimping section and the flange portion.

(B2) The motor according to (B1), wherein a conductive tape or a conductive paste is interposed between the female screw portion and the terminal.

(B3) The motor according to (B1) or (B2), further including a plurality of the bus bars through which currents having phases different from each other flow, a plurality of the connector portions fixed, respectively, to the bus bars different from each other, a plurality of the cables connected to the connector portions different from each other, and an insulator including a wall portion located between the connection end portions of the bus bars different from each other.

(B4) The motor according to any one of (B1) to (B3), wherein the stator includes a first stator located on one side in the axial direction of the rotor and a second stator located on the other side in the axial direction of the rotor, the bus bar includes a first bus bar connected to the first stator and a second bus bar connected to the second stator, the connector portion includes a first connector portion fixed to the first bus bar and a second connector portion fixed to the second bus bar, and the cable includes a first cable connected to the first connector portion and a second cable connected to the second connector portion.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable around a center axis;
a first stator opposing the rotor in an axial direction and located on one side in the axial direction of the rotor;
a second stator opposing the rotor in the axial direction and located on another side in the axial direction of the rotor;
a first bus bar connected to the first stator;
a second bus bar connected to the second stator;
a first connector portion fixed to the first bus bar;
a second connector portion fixed to the second bus bar;
a housing to house the rotor, the first stator, the second stator, the first bus bar, and the second bus bar;
a first cable connected to the first connector portion and drawn out to an outside of the housing; and
a second cable connected to the second connector portion and drawn out to the outside of the housing; wherein
the housing includes:
a first hole portion extending from the first connector portion toward one side in the axial direction; and
a second hole portion extending from the second connector portion toward one side in the axial direction;
the first cable is connected to the first connector portion from one side in the axial direction through the first hole portion;
the second cable is connected to the second connector portion from one side in the axial direction through the second hole portion;
the second connector portion is on an outer side in a radial direction of the second stator; and
the second hole portion extends from the second connector portion, through the outer side in the radial direction of the second stator and the first stator, to one side of the housing in the axial direction.

2. The motor according to claim 1, further comprising:
a cable cover to surround at least one of the first cable or the second cable from an outer side in a radial direction with respect to an axis extending in the axial direction;
wherein
the cable cover includes:
a base fixed to the housing;
a cap fixed to the base; and
a first seal having an annular shape;
the base includes a tubular screw portion to surround the cable from the outer side in the radial direction of the axis and including an outer circumferential surface on which a male screw portion is provided;
the cap includes:
a nut portion into which the male screw portion is inserted;
a holding tubular portion having a tubular shape surrounding the axis and extending from the nut portion toward one side in the axial direction; and
an inner protruding portion having an annular shape and protruding from an end portion of the holding tubular portion on one side in the axial direction toward the inner side in the radial direction of the axis; and
the first seal is sandwiched between the tubular screw portion and the inner protruding portion on an inner side in the radial direction of the holding tubular portion.

3. The motor according to claim 2, wherein
the base includes a flange portion protruding from an end portion of the tubular screw portion on the other side in the axial direction toward the outer side in the radial direction; and
a second seal is between the flange portion and a surface of the housing opposing one side in the axial direction.

4. The motor according to claim 1, wherein
at least one of the first bus bar or the second bus bar includes a connection end portion having a plate shape with the axial direction as a thickness direction;
the connection end portion is provided with a through-hole;
at least one connector portion of the first connector portion or the second connector portion includes:
a tubular portion inserted into the through-hole; and
a flange portion protruding from an end portion of the tubular portion in the axial direction toward the outer side in the radial direction;
the tubular portion includes:
a female screw portion provided on an inner circumferential surface; and
a crimping portion bulging toward the outer side in the radial direction and sandwich the connection end portion together with the flange portion; and
a terminal having a screw shape to be fastened to the female screw portion is provided at a tip portion of at least one cable of the first cable or the second cable.

5. The motor according to claim 4, wherein a conductive tape or a conductive paste is between the female screw portion and the terminal.

6. The motor according to claim 4, further comprising:
a plurality of the bus bars through which flow currents having phases different from each other;
a plurality of the connector portions fixed, respectively, to different ones of the bus bars;
a plurality of the cables connected, respectively, to different ones of the connector portions; and
an insulator including a wall portion located between the connection end portions of the bus bars different from each other.

7. The motor according to claim 1, further comprising:
a shaft fixed to the rotor and extending in the axial direction around the center axis;
a bearing located on the other side in the axial direction of the rotor to rotatably support the shaft; and
a bearing cover fixed to the shaft, extending from the shaft toward the outer side in the radial direction, to cover the bearing from the other side in the axial direction.

8. The motor according to claim 7, wherein
the housing includes a bearing holder portion having a tubular shape configured to hold the bearing;
a groove portion having an annular shape and extending along a circumferential direction is provided on a surface of the bearing holder portion opposing the other side in the axial direction;
the bearing cover includes:
a cover body portion having a plate shape with the axial direction as a thickness direction;
an annular protrusion having an annular shape and protruding toward one side in the axial direction with respect to the cover body portion and inserted into the groove portion; and
a tubular portion protruding toward one side in the axial direction, with respect to the cover body portion, on the outer side in a radial direction of the annular protrusion and surrounding the outer circumferential surface of the bearing holder portion from the outer side in the radial direction.
